(19) United States
(12) Patent Application Publication
(10) Pub. No.: US 2019/0335763 A1
(43) Pub. Date: Nov. 7, 2019

(54) Stabilization of Monocalcium Phosphate With Non-Aluminum Materials

(71) Applicant: ICL Specialty Products Inc., St. Louis, MO (US)

(72) Inventors: Olivera Zivkovic, St. Louis, MO (US); David R. Gard, St. Louis, MO (US); David P. Roberts, St. Louis, MO (US)

(21) Appl. No.: 15/972,916

(22) Filed: May 7, 2018

(51) Int. Cl. A21D 2/02

(52) U.S. Cl. CPC A21D 2/02

(57) ABSTRACT

Disclosed herein is a stabilized anhydrous monocalcium phosphate (MCPA) leavening composition comprising or consisting essentially of MCPA and a non-aluminum stabilizer. Whereas current commercial MCPA leavening compositions are stabilized by the addition of aluminum pyrophosphates, in certain aspects, the stabilized MCPA of this disclosure meets the European standard for allowable aluminum content in food products.

### BACKGROUND

Certain current leavening compositions comprise anhydrous monocalcium phosphate (MCPA) stabilized by an aluminum pyrophosphate coating that protects against premature leavening action by slowing dissolution and subsequent reaction with baking soda. Primary applications for such leavening compositions include: self-rising flour, phosphated flour, self-rising corn meal, cake and pancake mixes and household baking powders.

Since December 2012, EU regulations for food products limit aluminum content in monocalcium phosphate to maximum of 200 ppm (http world wide web address eur-lex.europa.eu/legal-content/EN/TXT/PDF/?uri=OJ:L:2012:083:FULL&from=EN). This limit is exceeded by aluminum pyrophosphate stabilized MCPA.

Thus, there remains a need to develop low aluminum leavening compositions that exhibit delayed reaction as an alternative to aluminum stabilization.

### SUMMARY

Provide herein are stabilized anhydrous monocalcium phosphate (MCPA) leavening compositions comprising MCPA and a non-aluminum stabilizer. In certain aspects, the MCPA is in an amount of about 80% to about 98%, by weight. In certain aspects, the non-aluminum stabilizer is in an amount of about 1.3% to about 8%, by weight. In certain aspects, non-aluminum stabilizer is in an amount of about 6% to about 7%, by weight. In certain aspects, the non-aluminum stabilizer comprises at least one ingredient selected from the group of ingredients consisting of DKP, MKP, TKPP, MgO, MgCO₃, Mg(OH)₂, and Ca(OH)₂. In certain aspects, the non-aluminum stabilizer comprises at least one of each of the following: (i) a potassium phosphate; and (ii) a magnesium or calcium base. In certain aspects, the potassium phosphate comprises at least one potassium phosphate selected from the group consisting of DKP, MKP, and TKPP. In certain aspects, the magnesium or calcium base comprises at least one base selected from the group consisting of MgO, MgCO₃, Mg(OH)₂, and Ca(OH)₂. For example, in certain aspects, the non-aluminum stabilizer comprises DKP and MgO. In certain aspects, the potassium phosphate and base combined are in an amount of about 1.3% to about 8%, by weight, or the potassium phosphate and base combined are in an amount of about 6% to about 7% by weight. Further, in certain aspects, [K+Mg] is from about 0.7% to about 4%, by weight. In certain aspects, the potassium phosphate is in an amount of about 1% to about 6%, by weight. In certain aspects, the potassium phosphate is in an amount of about 3% to about 6%, by weight. In certain aspects, the magnesium or calcium base is in an amount of about 0.3% to about 2%, by weight. In certain aspects, the magnesium or calcium base is in an amount of about 0.7% to about 1.4%, by weight. For example, in certain aspects, the DKP is in an amount of about 1% to about 6%, by weight. For example, in certain aspects, the DKP is in an amount of about 3% to about 6%, by weight. For example, in certain aspects, the MgO is in an amount of about 0.3% to about 2%, by weight. For example, in certain aspects, the MgO is in an amount of about 0.7% to about 1.4%, by weight. In certain aspects, the leavening composition comprises a K/Mg mole ratio of from about 0.3 to about 10, of from about 1 to about 5, of from about 2 to 6, or of from about 1.35 to about 3.4. In certain aspects, stabilization of MCPA is achieved without utilizing an aluminum compound. In certain aspects, the leavening composition does not contain added aluminum phosphates. In certain aspects, the leavening composition comprises less than about 1000 ppm, 900 ppm, 800 ppm, 700 ppm, 600 ppm, 500 ppm, 450 ppm, 400 ppm, 350 ppm, 300 ppm, 250 ppm, 200 ppm, 150 ppm, or 100 ppm of aluminum. In certain aspects, the stabilized MCPA leavening composition exhibits delayed reactivity (as defined elsewhere herein) with baking soda in a dough mixture in comparison with a control of MCPA without stabilization. In certain aspects, said reactivity is quantified as the dough rate of reaction (DRR). In certain aspects, the reactivity is significantly delayed (as defined elsewhere herein). In certain aspects, the stabilized MCPA leavening composition exhibits similar reactivity (as defined elsewhere herein) with baking soda in a dough mixture in comparison with a control leavening composition of MCPA coated with MALP. As noted, in certain aspects, said reactivity is quantified as the dough rate of reaction (DRR). In certain aspects, the stabilized MCPA leavening composition exhibits delayed reactivity with baking soda in a dough mixture in comparison with a control leavening composition of MCPA coated with monoaluminum phosphate MALP. As noted, in certain aspects, said reactivity is quantified as the dough rate of reaction (DRR). In certain aspects, the 2′ DRR is <55, <50, <45, or <40. In certain aspects, the 2′ DRR is between about 30 and about 55, between about 30 and about 50, between about 30 and 45, between about 30 and 40, between about 35 and about 55, between about 35 and about 50, or between about 35 and about 45. In certain aspects, the leavening composition has a neutralizing value (NV) of at least 60, at least 65, at least 70, at least 75, or at least 80.

### BRIEF DESCRIPTION OF THE DRAWINGS/FIGURES

FIG. 1. Shows a schematic of stabilized MCPA production.

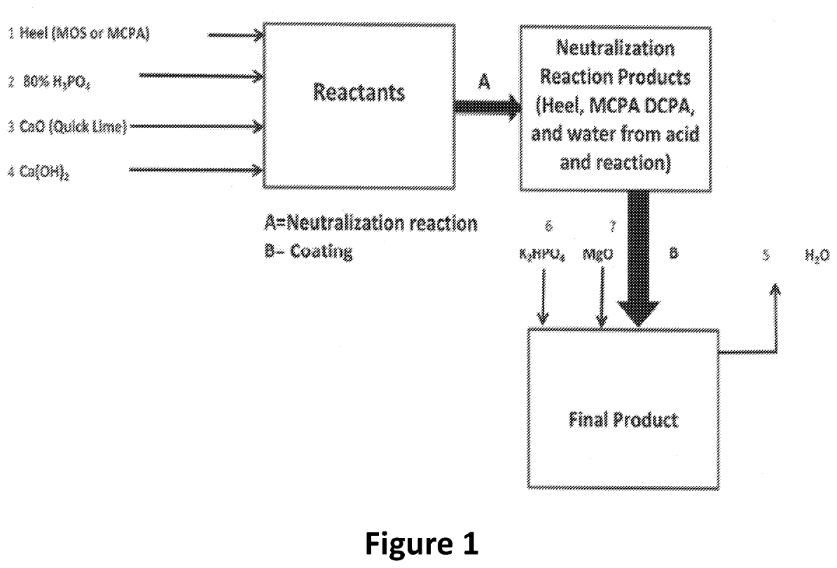

### DETAILED DESCRIPTION

### Definitions

To the extent necessary to provide descriptive support, the subject matter and/or text of the appended claims is incorporated herein by reference in their entirety.

It will be understood by all readers of this written description that the exemplary embodiments described and claimed herein may be suitably practiced in the absence of any recited feature, element or step that is, or is not, specifically disclosed herein.

It is to be noted that the term “a” or “an” entity refers to one or more of that entity; for example, “a composition,” is understood to represent one or more compositions. As such, the terms “a” (or “an”), “one or more,” and “at least one” can be used interchangeably herein.

Furthermore, “and/or” where used herein is to be taken as specific disclosure of each of the specified features or components with or without the other. Thus, the term and/or” as used in a phrase such as “A and/or B” herein is intended to include “A and B,” “A or B,” “A” (alone), and “B” (alone). Likewise, the term “and/or” as used in a phrase such as “A, B, and/or C” is intended to encompass each of the following embodiments: A, B, and C; A, B, or C; A or C; A or B; B or C; A and C; A and B; B and C; A (alone); B (alone); and C (alone).

It is understood that wherever aspects are described herein with the language “comprising,” otherwise analogous aspects described in terms of “consisting of” and/or “consisting essentially of” are also provided.

Unless defined otherwise, technical and scientific terms used herein have the same meaning as commonly understood by one of ordinary skill in the art to which this disclosure is related. Numeric ranges are inclusive of the numbers defining the range. Even when not explicitly identified by “and any range in between,” or the like, where a list of values is recited, e.g., 1, 2, 3, or 4, unless otherwise stated, the disclosure specifically includes any range in between the values, e.g., 1 to 3, 1 to 4, 2 to 4, etc.

The headings provided herein are solely for ease of reference and are not limitations of the various aspects or aspects of the disclosure, which can be had by reference to the specification as a whole.

As used herein, the terms “stabilizing” and “stabilization,” such as for modifying “material” (“stabilizing material” or “stabilization material”) or “concentration” (“stabilizing concentration” or “stabilization concentration”), or the like, are used interchangeably.

Unless otherwise specified, mass amounts are provided as weight %.

Leavening compositions—also known as leavening agents, leavening acids, a leaven, or a raising agent—are compounds or mixtures that release gas (e.g., CO₂) when they react with baking soda, moisture, and/or heat. Leavening agents can be used, for example, in doughs and batters to cause a release of gas that lightens, softens, or otherwise provides a desired texture, structure, crumb, or the like to the mixture and/or product prepared therefrom. For example, when a dough or batter is mixed, the starch in the flour and the water in the dough can form a matrix (often supported by proteins like gluten or polysaccharides, such as pentosans or xanthan gum), after which the starch gelatinizes and sets, leaving gas bubbles that remain.

The present disclosure provides for stabilized anhydrous monocalcium phosphate (MCPA) leavening compositions. MCPA (Ca(H₂PO₄)₂) is also referred to in the art as calcium dihydrogen phosphate, aCMP, CMP-A, or monocalcium phosphate anhydrous, among others. MCPA is widely used in the food industry as a leavening agent. Because it is acidic, when combined with an alkali ingredient, commonly sodium bicarbonate (baking soda) or potassium bicarbonate, MCPA reacts to produce carbon dioxide and a salt. For baking applications, when MCPA is used in a ready-made baking powder, the acid and alkali ingredients are used in the right proportions so that they will neutralize each other and not significantly affect the overall pH of the product, which is highly desired for baked products. Generally, MCPA is considered a fast acting leavening agent, because it releases most of the carbon dioxide within minutes of mixing. By stabilized, it is meant that the MCPA exhibits delayed and/or slower reaction with baking soda, for example when incorporated into a dough or batter, as compared to unstabilized MCPA.

As disclosed herein, a stabilized MCPA leavening composition comprises MCPA and a non-aluminum stabilizer. In certain aspects, the leaving composition consists essentially of MCPA and a non-aluminum stabilizer. MCPA is the main component in the leavening composition and can be in an amount of from any of about 80%, 81%, 82%, 83%, 84%, 85%, 86%, 8′7%, 88%, 89%, or 90% to any of about 85%, 86%, 8′7%, 88%, 89%, 90%, 91%, 92%, 93%, 94%, 95%, 96%, 97%, 98%, or 99%, by weight. In certain aspects, the MCPA can be in an amount of from about 80% to about 98%, by weight. The non-aluminum stabilizer component can be in an amount of from any of about 1%, 2%, 3%, 4%, 5%, or 6% to any of about 4%, 5%, 6%, 7%, 8%, 9%, or 10%, by weight. In certain aspects, the non-aluminum stabilizer component can be in an amount of from about 1.3% to about 8%, by weight. In certain aspects, the non-aluminum stabilizer component can be in an amount of from about 6% to about 7%, by weight.

One of ordinary skill in the art would understand that MCPA leavening compositions can also contain some amount of dicalcium phosphate anhydrous (CaHPO₄; which can be referred to as DCP or DCPA). DCP is formed by the use of an excess of lime versus the theoretical amount to form only MCPA. In certain aspects, a stabilized MCPA leavening composition disclosed herein comprises DCP in an amount of from any of about 1%, 2%, 3%, 4%, 5%, 6%, 7%, 8%, 9%, or 10% to any of about 3%, 4%, 5%, 6%, 7%, 8%, 9%, 10%, 11%, 12%, 13%, 14%, or 15%, by weight. In certain aspects, a stabilized MCPA leavening composition comprises DCP in the amount of from about 1% to about 15%, by weight. In certain aspects, the leaving composition consists essentially of MCPA, a non-aluminum stabilizer, and DCP.

Current MCPA leavening compositions are stabilized by aluminum phosphates. This practice is undesirable and in some cases not commercially viable because of concerns and restrictions in some countries on the amount of allowable aluminum in food products. Provided herein are low aluminum alternatives in which aluminum containing stabilizers are not added. Rather, non-aluminum stabilizers are utilized. In certain aspects, the non-aluminum stabilizer can comprise, for example, at least one ingredient selected from the group of ingredients consisting of dipotassium phosphate (DKP; also known as dipotassium hydrogen orthophosphate or potassium phosphate dibasic), monopotassium phosphate (MKP; also known as potassium dihydrogenphosphate, KDP, or monobasic potassium phosphate), potassium pyrophosphate (TKPP; also known as tetrapotassium diphosphate or tetrapotassium pyrophosphate) MgO, MgCO₃, Mg(OH)₂, and Ca(OH)₂.

In certain aspects, the non-aluminum stabilizer comprises at least one of each of the following: (i) a potassium phosphate (e.g., DKP, MKP, and/or TKPP); and (ii) a magnesium or calcium base (e.g., MgO, MgCO₃, Mg(OH)₂, and/or Ca(OH)₂). In certain aspects, the combined amount of potassium phosphate and magnesium or calcium base is an amount of from any of about 1%, 2%, 3%, 4%, 5%, or 6% to any of about 4%, 5%, 6%, 7%, 8%, 9%, or 10%, by weight. In certain aspects, the combined amount of potassium phosphate and magnesium or calcium base is an amount of from about 1.3% to about 8%, by weight. In certain aspects, the combined amount of potassium phosphate and magnesium or calcium base is from about 6% to about 7%, by weight. In certain aspects, the potassium phosphate (e.g., DKP, MKP, and/or TKPP) is an amount of from any of about 0.5%, 1%, 2%, 3%, 4%, or 5% to any of about 4%, 5%, 6%, 7%, or 8%, by weight. In certain aspects, the potassium phosphate is in an amount of from about 1% to about 6%, by weight. In certain aspects, the potassium phosphate is in an amount of from about 3% to about 6%, by weight. In certain aspects, the magnesium or calcium base (e.g., MgO, MgCO₃, Mg(OH)₂, and/or Ca(OH)₂) is in an amount of from any of about 0.1%, 0.2%, 0.3%, 0.4%, 0.5%, or 1% to any of about 0.5%, 1%, 2%, or 3%, by weight. In certain aspects, the magnesium or calcium base is in an amount of from about 0.3% to about 2%, by weight. In certain aspects, the magnesium or calcium base is in an amount of from about 0.7% to about 1.4%, by weight.

One of ordinary skill in the art would recognize that the potassium phosphate and magnesium base contribute potassium (K) and magnesium (Mg) to the composition. In certain aspects, the combined amount of K and Mg in the composition ([K+Mg]) can be from any of about 0.5%, 0.6%, 0.7%, 0.8%, 0.9%, 1%, or 2% to any of about 2%, 3%, 4%, or 5%, by weight. In certain aspects, the amount is from about 0.7% to about 4%, by weight. In certain aspects, the K/Mg mole ratio is from any of about 0.1, 0.2, 0.3, 0.4, 0.5, 1, 2, 3, 4, or 5 to any of about 2, 3, 4, 5, 6, 7, 8, 9, or 10. In certain aspects, the K/Mg mole ratio is from about 0.3 to about 10. In certain aspects, the K/Mg mole ratio is from about 1 to about 5. In certain aspects, the K/Mg mole ratio is from about 2 to about 6. In certain aspects, the K/Mg mole ratio is from about 1.35 to about 3.4.

For the purposes of the present disclosure, the amount of “aluminum” refers to the amount of aluminum when expressed in its elemental form. In certain aspects of a stabilized MCPA leavening composition disclosed herein, the leavening composition comprises less than about 1000 ppm, 900 ppm, 800 ppm, 700 ppm, 600 ppm, 500 ppm, 450 ppm, 400 ppm, 350 ppm, 300 ppm, 250 ppm, 200 ppm, 150 ppm, 100 ppm, or 50 ppm of aluminum, or any range in between. In certain aspects of a stabilized MCPA leavening composition disclosed herein, the leavening composition comprises less than about 300 ppm, 250 ppm, 200 ppm, 150 ppm, 100 ppm, or 50 ppm of aluminum, or any range in between. In certain aspects, stabilization of MCPA can be achieved without the utilization of an aluminum containing compound. For example, wherein the leavening composition does not contain added aluminum phosphates.

Stabilization (i.e., delayed reactivity) of an MCPA leavening composition disclosed herein can be made by quantitative comparison to unstabilized MCPA or to MCPA stabilized by other means, such as by the use of added aluminum. In certain aspects, the stabilized MCPA leavening composition exhibits delayed reactivity with baking soda in a dough mixture in comparison with a control of MCPA without stabilization. In certain aspects, the reactivity can be quantified as the dough rate of reaction (DRR) (for example as measured after 2 minutes (2′ DRR)) as is described elsewhere herein and known to those of ordinary skill in the art. By “delayed reactivity” it is meant that the 2′ DRR at 27° C. is less than about 45. In certain aspects the reactivity can be significantly delayed. By “significantly delayed” it is meant that the 2′ DRR at 27° C. is less than about 36. In certain aspects of any compositions disclosed herein, the stabilized MCPA leavening composition can exhibit similar reactivity with baking soda in a dough mixture in comparison with a control leavening composition of MCPA coated with monoaluminum phosphate (MALP). By “similar reactivity” it is meant that the 2′ DRR at 27° C. is less than about 36 and the ΔDRR is at least 42. In certain aspects, the stabilized MCPA leavening composition can exhibit delayed reactivity (i.e., at least 5% slower) with baking soda in a dough mixture in comparison with a control leavening composition of MCPA coated with MALP.

In certain aspects, the two minute DRR (2′ DRR) of the stabilized MCPA leavening composition can be <60, <55, <50, <45, <40, <35, or <30. In certain aspects, the 2′ DRR can be between about 30 and about 55, between about 30 and about 50, between about 30 and 45, between about 30 and 40, between about 35 and about 55, between about 35 and about 50, between about 35 and about 45.

Neutralizing value is the measure of the available acidity in leavening acids. The value is used to determine the amount of acid or acids needed so when combined with, for example, sodium bicarbonate, it produces a neutral pH. NV represents the number of parts of, for example, sodium bicarbonate, that can be neutralized by 100 parts of the leavening acid. In certain aspects, the stabilized MCPA leavening composition can have a neutralizing value (NV) of at least 60, at least 65, at least 70, at least 75, at least 80, or at least 85.

The following examples are included to demonstrate certain embodiments of the disclosure. It should be appreciated by those of skill in the art that the techniques disclosed in the examples which follow represent techniques discovered by the inventor to function well in the practice of the disclosure. However, those of skill in the art should, in light of the present disclosure, appreciate that many changes can be made in the specific embodiments which are disclosed and still obtain a like or similar result without departing from the spirit and scope of the disclosure.

### EXAMPLES

### Example 1

A trial to produce stabilized MCPA that contained low aluminum or that was aluminum free (i.e., did not have aluminum ortho- or pyrophosphate added) was conducted. A procedure similar to that of commercial produced aluminum stabilized MCPA (e.g., PYRAN from ICL Specialty Products Inc.) was used, with the addition of DKP and MgO as stabilizing materials instead of MALP solution. Moisture inherent to the MCPA production was deemed sufficient for subsequent stabilization reaction. Three mixes were made; mix #2 and mix #3 were processed to the finished products at 175 and 200° C. fluidizer temperatures, respectively. Initial heel material was MCPA. Aluminum content in the heel of MCPA affected the aluminum content of the final product. Product contained >10% of total solids as DCPA, due to the high Ca/P ratio in the mix. The highest neutralizing value of the finished product was ˜69. Product obtained at 175° C. fluidizer had 2′ DRR value (DRR after 2 minute reaction) below the production spec for the commercial PYRAN (˜34). Higher fluidizer temperature (200° C.) resulted in the product with higher 2′ DRR (˜44-46).

### I. Introduction

PYRAN. PYRAN is a commercial, anhydrous monocalcium phosphate (MCPA) with a coating that delays the MCPA solubility and its release in the dough mixture and reaction with baking soda and thus, prolongs the bench time. The delay is quantified in the dough rate of reaction (DRR) experiment as % of the total CO₂ released in the early stage of the experiment (2′ DRR). PYRAN typically releases less than ˜50% of the CO₂ in the DRR test compared with unmodified MCPA. MCPA coating in PYRAN is formed from monoaluminum phosphate (MALP) added at the end of MCPA formation as 65 wt % solution. Coating that prevents fast dissolution of leavening acid in the bakery applications is aluminum pyrophosphate formed during the heating of material in the fluidizer at ˜225° C. Aluminum content in PYRAN is ˜0.9-1 wt %.

Aluminum Free PYRAN. As disclosed herein, alternative materials for stabilizing MCPA and the reaction conditions were tested on a laboratory scale. The nature of the aluminum free MCPA stabilizing structure was not well known. Without being bound to theory, it was contemplated that due to the relatively low temperatures used in the process, it may not be a coating in the sense of aluminum pyrophosphate as in PYRAN, however, where the term “coating” is used herein, it is as an alternative (i.e., interchangeable) descriptor of aluminum free stabilization of MCPA. The laboratory scale research helped determine initial conditions for feasibility trial on the production scale (stabilizing material amount, water content in the reaction mixture, minimum heating/drying temperature). DKP and MgO were choices for the MCPA stabilization.

### II. Process Description

### A. PYRAN Process

PYRAN is produced by first mixing recycled MCPA with phosphoric acid at 60° C. to prepare a starting “heel.” The recycled MCPA is typically milled oversize (MOS) PYRAN from previous production. The heel typically contains ˜25% of the batch weight and 35% of the total acid. Quicklime and the remainder of the acid are then added simultaneously as they are mixed with the heel. The acid addition is completed shortly before the lime addition to ensure more complete reaction and minimize the amount of free acid. A small amount of hydrated lime is added to achieve target Ca/P. A solution of monoaluminum phosphate is added as a coating agent. Another charge of quick lime and hydrated lime are added. Mixing and heating continues until reaching 110° C. to minimize MCPM content. TCP is added to the mixer after drying step. After discharging the material from the mixer it is screened to remove the +120 mesh material. The −120 mesh material is conveyed to the fluidizer feed bin. Fines are heated in the fluidizer for 75 minutes after reaching 210° C. Charge should reach at least 225° C. before the end of the batch. TCP is added and product cooled to less than 100° C., after which material is packed in paper/plastic bags/or supersacks. Total content of TCP as flow conditioner is ˜2%.

### B. Trial Process Description

A trial to produce stabilized MCPA with aluminum free material was conducted. A total of three mixes were made, with two mixes processed to the finished product stage. This trial demonstrated large scale production of aluminum free MCPA is feasible. The trial process was run on the same facility used for PYRAN production with the following modifications. Heel material was MCPA produced with low aluminum content. 35% of total acid was added to prepare the heel. After preparing the heel material (MCPA and heel acid), control acid and quick lime were added, respectively. DKP and MgO were added in place of the monoaluminum solution. Mixing and heating continued until material LOD (10′ at 150° C.) was sufficiently low (<0.5%). TCP was added at 2.2% level and mixed for ˜15′ before screening through 120 mesh screens. −120 mesh materials was conveyed to the fluidizer and heated for a total of 2 hours from reaching the set temperature. Fluidizer temperatures tested in this trial were 175 and 200° C.

### III. Conclusions

MCPA reactivity can be modified with aluminum free material (DKP and MgO) on the production scale. Delayed reactivity, similar to commercial PYRAN, was demonstrated. Delay in the reactivity was achieved with material processed on 175° C. fluidizer: 2′ DRR was ˜34-36. Other material produced at 200° C. fluidizer was significantly more reactive (2′ DRR ˜44-47).

### IV. Experimental

### Raw Materials

TABLE 1
List of raw materials used in the trial.

| Chemical | Material # | Comments |
|---|---|---|
| MCPA | 10004465 | Heel for mix#1 and 2, batch |
| | | 68894 |
| MCPA as MOS | 20000748 | Heel for mix#3 from mix#2 |
| 80% H₃PO₄ | 20000325 | |
| Calcium Oxide, CaO | 30000797 | Microcal 0, quick lime |
| Calcium Hydroxide | 30000093 | Min 74% |
| Dipotassium phosphate (DKP) | 10003158 | Granular |
| Magnesium Oxide (MgO) | 30000862 | Dead Sea Periclase |
| TriCalcium Phosphate (TCP) | 10000184 | Flow agent |

### Analytical Procedures

Sizing, % LOD, and % DCPA were determined on the in-process samples, collected during the drying in the mixer, in the unit lab. A −100 mesh USSS screen was used to measure oversize in the unit lab. LOD was measured in the unit lab on a Mettler moisture analyzer at 150° C. for 10′. % DCPA was measured by titration method. Quick caking test, performed in the unit lab, was based mostly on the visual observation and comparisons of mixer material after ˜30 minutes to up to an hour without and with TCP as a flowing agent. The material flow was also evaluated by crude spatula test.

Analyses were completed on materials collected from fluidizer, packaged product and milled oversize (MOS) using the standard plant laboratory methods for PYRAN: LOD, LOI, free acid, metal content (Al, Ca, K, Mg, % P₂O₅, Sizing, NV, and DRR).

### Mixer Samples Additional Testing

Several samples collected from the mixer and before sending to fluidizer were heated in the laboratory at temperatures used in the fluidizer (175 and 200° C.) for an hour.

### V. Results and Discussion

### 1. Trial Description

### A. Mixer

Each mix is described below. Three half batches (˜4000 lbs) were prepared in the trial. Common to all the mixes were: low aluminum grade (˜150 ppm) quick lime and standard hydrated lime; heel acid was 35% of the total acid; acid concentration was 80%; acid temperature 60° C.; sweep air inlet temperature 140° C. Summary of the materials used in the mixes preparation is in Table 2.

TABLE 2
Materials used in the mixes.

| Raw Materials | Mix #2 | Mix #3 |
|---|---|---|
| 80% H₃PO₄ Acid | 3031 | 3031 |
| MCPA milled | 1047 | 1250 |
| oversize (MOS) | | |
| CaO (lbs) | 600 | 600 |
| Ca(OH)₂ (lbs) | 200 | 200 |
| DKP (lbs) | 213 | 150 |
| MgO (lbs) | 40 | 28 |
| TCP (lbs) | 100 | 100 |
| Total (lbs) | 5231 | 5359 |
| Total Reactants (lbs) | 4625 | 4753 |
| Total Dry | 4402 | 4530 |
| Material (lbs) | | |
| External water (lbs) | 606 | 606 |
| % external moisture | 12 | 11 |
| water from rxn (lbs) | 446 | 446 |
| % total water | 20 | 20 |
| % DKP added | 4.84 | 3.31 |
| % MgO added | 0.91 | 0.62 |
| % K added | 2.17 | 1.49 |
| % Mg added | 0.55 | 0.37 |
| added K/Mg mole | 2.46 | 2.48 |

*heel material for mix #3 was milled oversize material from the mix #2 production

TABLE 3
Raw material addition rates and characteristics of the mixes by the end
of mixing.

| | | | | | DCPA | | |
|---|---|---|---|---|---|---|---|
| | Addition | | Mixing | | as % of | | |
| | Rate lbs/min | | Time | | total P₂0₅ | % | % + 100 |
| Mix# | Acid | CaO | (h) | Tₘₐₓ(° C.) | content | LOD | mesh |
| 2 | 135 | 45 | 6 | 115 | 7.9 | 0.2 | 21.6 |
| 3 | 135 | 45 | 6 | 110 | 6.5 | 0.22 | 17.4 |

Table 3 lists acid and lime addition rates with characterization parameters of each mix at the end of mixing and before adding TCP and sieving.

Mix #2 Preparation. Mix #2 was prepared as described above. The heel was prepared from MCPA and acid. Following the addition of acid and quicklime, hydrated lime was added. DKP was then added, followed by MgO. After 3 hours of drying the LOD was 0.2%, % DCPA 7.9 (as a percent of the total P₂O₅ content) and % of 100 mesh oversized material was 21.6. 2.2% was added as a flow conditioner.

Mix #3 Preparation. The heel for the mix #3 was milled oversize material (MOS) produced in the mix #2 and made up 30% of the batch on the total reactants basis. The amount of stabilizing materials, DKP and MgO added was 70% of the ones used and mix #2, as can be seen in the Table 2 above. 2.2% TCP was added after the mix dried to LOD at ˜0.22%. Mix #3 had 17.4% of 100 USSS oversize and contained 6.5% DCPA (as a percent of the total P₂O₅ content).

### B. Post Mixer-Sizing and Fluidizer

The samples collected from 175° C. fluidizer were labeled PYRAN E1 Ch1 D, and the samples from 200° C. fluidizer were labeled PYRAN E1 Ch1 D.

### B. Aluminum Content

European regulations impose maximum 200 ppm of aluminum. Assuming that in the trial, only aluminum sources are MCPA heel material (800 ppm Al) that makes up 25% of the batch and quick lime (150 ppm Al) that contributes with 75% of the MCPA in the batch, estimate is (0.25*800 ppm+0.75*150 ppm) that aluminum content in the whole batch would be ˜312 ppm. Since quick lime aluminum content is pretty much the lowest available (150 ppm), the same rationale also suggests that maximum aluminum content in the MCPA heel material should not be more than 350 ppm if the aluminum in the whole batch is to be kept at maximum 200 ppm.

Aluminum content in the material from the mixer (Table 4A) is ˜342 ppm for mix #2, which is in relatively good agreement with the above estimate based on the aluminum source from lime and heel MCPA only (312 ppm). Mixer material from the mix #3 had more aluminum, ˜403-407 ppm of aluminum, and unaffected by the addition of TCP to the mix.

Upon further processing (sifting, sizing, and heating in the fluidizer) there was no significant change in the aluminum content from the one in the materials sampled from mixer, as can be seen in Table 4B and Table 4C. Aluminum in the fines from the fluidizer is 334, and ˜390 ppm and the in the packed material is ˜349 and ˜400 ppm, as can be seen in Tables 4B and Table 4C. This indicates that, passed the mixer, contribution of the processing equipment to the aluminum content to the final product is minimal to none. Milled oversize has much higher aluminum (˜525-530 ppm), as typically MOS accumulates aluminates.

TABLE 4A
Aluminum in the material from the mixer.

| Sample ID | Al (ppm) |
|---|---|
| AFP_12 PM Mix #2 | 342 |
| Mix #3-12 PM before TCP | 407 |
| Mix #3 Fines Before | 403 |
| Fluidizer | |

TABLE 4B
Aluminum content in the fines from fluidizer.

| Fines from Fluidizer Sample ID | Al (ppm) |
|---|---|
| PYRAN E1_Ch1_D (mix #2) | 334 |
| PYRAN E1_Ch2_D (mix #3) | 393 |

TABLE 4C
Aluminum content in the packed material and MOS.

| Sample ID | Al (ppm) |
|---|---|
| 69989 Bag 1 (mix #2) | 349 |
| 69998 Bag 10 (mix #3) | 386 |
| 69998 Bag 20 (mix #3) | 398 |
| 69998 Bag 30 (mix #3) | 401 |
| 69998 Bag 40 (mix #3) | 399 |
| 69998 Bag 50 (mix #3) | 403 |
| 70000 Bag 10 (mix #3) | 525 |
| 70000 Bag last (mix #3) | 530 |

### C. LOD, LOI, and the Free Acid

LOD was <0.1% for all the samples tested and similar to commercial PYRAN: the fines from fluidizer, packed material and MOS (Table 5A and Table 5B).

The free acid content was very low in the samples from mix #2 (PYRAN E1_Ch1_D), fines from fluidizer and packed material, as shown in Table 5A and Table 5B. Fines from fluidizer from the mix #3 (PYRAN E1_Ch2_D) and MOS from the same charge had free acid content an order of magnitude higher than the material from mix #2, but the packed product free acid content was similar to the product from mix #2.

TABLE 5A
LOD, LOI and free acid in fines from fluidizer.
Fines from Fluidizer

| Sample ID | LOD (%) | LOI (%) | free acid (%) |
|---|---|---|---|
| PYRAN E1_Ch1_D (mix #2) | 0.08 | 12.96 | 0.04 |
| PYRAN E1_Ch2_D (mix #3) | 0.07 | 12.78 | 1.41 |

TABLE 5B
LOD, LOI and free acid in the packed product and MOS.

| Sample ID | LOD | LOI (%) | free acid (%) |
|---|---|---|---|
| 69989 Bag 1 (mix #2) | 0.02 | 12.80 | 0.07 |
| 69998 Bag 10 (mix #3) | 0.04 | 12.82 | 0.03 |
| 69998 Bag 20 (mix #3) | 0.06 | 12.78 | 0.03 |
| 69998 Bag 30 (mix #3) | 0.05 | 12.76 | 0.04 |
| 69998 Bag 40 (mix #3) | 0.04 | 12.79 | 0.08 |
| 69998 Bag 50 (mix #3) | 0.05 | 12.80 | 0.02 |
| 70000 Bag 10 (mix #3) | 0.05 | 12.37 | 1.09 |
| 70000 Bag last (mix #3) | 0.05 | 11.98 | 0.54 |

### F. Sizing

Sizing of the fluidized charges, packed product, and MOS are given in Tables 6A and 6B. Overall, the tested production conditions resulted in the product with acceptable sizing.

TABLE 6A
Sizing of the fines in fluidizer.

| | Sizing | | |
|---|---|---|---|
| | %+50, | %+100, | %+200, |
| Fines from Fluidizer Sample ID | calc. | calc. | calc. |
| PYRAN E1_Ch1_D (mix #2) | 0.12 | 0.22 | 12.76 |
| PYRAN E1_Ch2_D (mix #3) | 0.12 | 0.14 | 8.10 |

TABLE 6B
Sizing of the packed material and MOS.

| | Sizing | | |
|---|---|---|---|
| | %+50, | %+100, | %+200, |
| Sample ID | calc. | calc. | calc. |
| 69989 Bag 1 (mix #2) | 0.02 | 0.12 | 12.00 |
| 69998 Bag 10 (mix #3) | 0.00 | 0.10 | 10.90 |
| 69998 Bag 20 (mix #3) | 0.00 | 0.04 | 10.06 |
| 69998 Bag 30 (mix #3) | 0.00 | 0.06 | 9.62 |
| 69998 Bag 40 (mix #3) | 0.00 | 0.02 | 9.84 |
| 69998 Bag 50 (mix #3) | 0.02 | 0.06 | 9.82 |
| 70000 Bag 10 (mix #3) | 0.00 | 0.10 | 5.10 |
| 70000 Bag last (mix #3) | 0.02 | 0.08 | 4.90 |

### H. % Ca, K, and Mg

Analyses for % Ca, % K, and % Mg are given in Tables 7A-C.

TABLE 7A
Ca, K, and Mg in the samples from mixer collected before adding
TCP, and after sizing.

| Sample ID | % Ca | % K | (ppm) Mg |
|---|---|---|---|
| AFP_12 PM Mix #2 | 19.87 | 1.89 | 7247 |
| Mix #3″ 12 PM before TCP | 19.77 | 2.13 | 5787 |
| Mix #3 Fines Before | 20.19 | 1.77 | 6181 |
| Fluidizer | | | |

TABLE 7B
Ca, K, and Mg content in fines from fluidizer.

| Fines from Fluidizer Sample ID | % Ca | % K | (ppm) Mg |
|---|---|---|---|
| PYRAN E1_Ch1_D (mix #2) | 17.59 | 1.88 | 6345 |
| PYRAN E1_Ch2_D (mix #3) | 21.18 | 1.83 | 6094 |

TABLE 7C
Ca, K, and Mg content in the packed material and MOS.

| Sample ID/MOS | % Ca | % K | (ppm) Mg |
|---|---|---|---|
| 69989 Bag 1 (mix #2) | 19.29 | 1.78 | 6125 |
| 69998 Bag 10 (mix #3) | 18.22 | 1.72 | 6248 |
| 69998 Bag 20 (mix #3) | 17.71 | 1.76 | 6082 |
| 69998 Bag 30 (mix #3) | 18.39 | 1.76 | 6108 |
| 69998 Bag 40 (mix #3) | 19.83 | 1.83 | 6107 |
| 69998 Bag 50 (mix #3) | 18.30 | 1.79 | 6147 |
| 70000 Bag 10 (mix #3) | 18.12 | 1.95 | 5143 |
| 70000 Bag last (mix #3) | 18.12 | 1.93 | 5083 |

### I. % P₂O₅

Analyses of total P₂O₅ on samples from the mixer, fluidizer, product, and MOS are provided in Tables 8A-C.

TABLE 8A
% Ca and P₂0₅ in the samples from the mixer.

| Mixer Samples ID | % Ca | % P | % P₂0₅ | mole CaO/P₂0₅ |
|---|---|---|---|---|
| AFP_12 PM Mix #2 | 19.87 | 24.54 | 56.23 | 1.25 |
| Mix #3 - 12 PM before TCP | 19.77 | 25.15 | 57.63 | 1.21 |
| Mix #3 Fines Before Fluidizer | 20.19 | 25.51 | 58.46 | 1.22 |

TABLE 8B
% P₂0₅ in fines from fluidizer.

| Fines from Fluidizer Sample ID | % P₂0₅ | mole CaO/P₂0₅ |
|---|---|---|
| PYRAN E1_Ch1_D (mix #2) | 58.95 | 1.06 |
| PYRAN E1_Ch2_D (mix #3) | 57.48 | 1.30 |

TABLE 8C
% P₂0₅ in the packed product and MOS.

| | | mole |
|---|---|---|
| Sample ID | % P₂0₅ | CaO/P₂0₅ |
| 69998 Comp (mix #3) | 57.34 | 1.14 |
| 70000 Comp (mix #3) | 56.85 | 1.13 |

### K. NV and DRR

Neutralizing Value and DRR data are provided in Table 9A and Table 9B for fines processed in the fluidizer, packed product, and milled oversize material.

TABLE 9A
NV and DRR values for fines from fluidizer.

DRR

| Fines from Fluidizer Sample ID | NV | 2′ | ΔDRR |
|---|---|---|---|
| PYRAN E1_Ch1_D (mix #2) | 69.80 | 35.60 | 34.00 |
| (processed at 175° C. in the fluidizer) | | | |
| PYRAN E1_Ch2_D (mix #3) | 67.38 | 45.90 | 25.50 |
| (processed at 200° C. in the fluidizer) | | | |

TABLE 9B
NV and DRR values for packed material and MOS.

DRR

| Sample ID | NV | 2′ | ΔDRR |
|---|---|---|---|
| 69989 Bag 1 (mix #2) | 68.28 | 34.40 | 34.20 |
| 69998 Bag 10 (mix #3) | 68.32 | 44.00 | 26.20 |
| 69998 Bag 20 (mix #3) | 67.72 | 45.30 | 24.60 |
| 69998 Bag 30 (mix #3) | 67.47 | 45.90 | 23.60 |
| 69998 Bag 40 (mix #3) | 67.59 | 45.60 | 24.50 |
| 69998 Bag 50 (mix #3) | 68.64 | 46.50 | 25.50 |
| 70000 Bag 10 (mix #3) | 61.40 | 43.90 | 22.80 |
| 70000 Bag last (mix #3) | 61.59 | 43.80 | 22.40 |

Finished charge and packed materials from mix #2 processed at 175° C. in the fluidizer exhibit 2′ DRR 34-36 and ΔDRR ˜34. Finished charge and packed materials from mix #3 processed at 200° C. in the fluidizer exhibit 2′ DRR 44-47 and ΔDRR ˜24-26. Neutralizing values are in the range of ˜67-70 for materials from both mixes.

MOS from mix 3 has comparatively low values for NV, 2′ DRR and ΔDRR.

### 2. Mixer Samples Additional Laboratory Testing

Samples derived from mixes #2 and #3, were additionally processed in the laboratory. Mix samples were screened on 100 mesh and the fines heated for an hour at 175 and 200° C. The heated fines were characterized by NV and DRR (Tables 10A and 10B).

TABLE 10A
Selected Mix #2-3 samples heated in the laboratory at
175° C. for 1 hour.

| | Heated | % Weight | | | |
|---|---|---|---|---|---|
| Trial sample ID | Sample ID | Loss | NV | 2′DRR | ΔDRR |
| Mix #2 | 0353-075-B | 0.67 | 70.41 | 34.9 | 41 |
| (AFP_12pm, | | | | | |
| before TCP) | | | | | |
| Mix #3 (12 pm, | 0353-075-C | 0.54 | 73.23 | 41.4 | 36.8 |
| before TCP) | | | | | |
| Mix #3 | 0353-075-D | 0.2 | 75.1 | 41.3 | 33.8 |
| (Fines before | | | | | |
| fluidizer) | | | | | |

TABLE 10B
Selected Mix #2-3 samples heated in the laboratory at
200° C. for 1 hour.

| | Heated | % Weight | | | |
|---|---|---|---|---|---|
| Trial sample ID | Sample ID | Loss | NV | 2′DRR | ΔDRR |
| Mix#2(AFP_12pm, | 0353-077-B | 0.92 | 70.68 | 34.1 | 39.2 |
| before TCP) | | | | | |
| Mix#3(⁻12 pm, | 0353-077-C | 0.72 | 73.93 | 38 | 39.4 |
| before TCP) | | | | | |
| Mix#3(Fines before | 0353-077-D | 0.32 | 71.63 | 44.4 | 32.1 |
| fluidizer) | | | | | |

The NV and DRR values for the individual samples are fairly similar irrespective of the heating temperature. The largest difference is between the NV values for sample 0353-077-D when heated at 175° C. vs. 200° C. This indicates the 25° C. difference in heating temperature may have less of an effect on the NV and DRR values in comparison with the composition of the individual samples.

The laboratory-processed mix #2 may be compared with the corresponding plant-processed mix #2 samples, also heated at 175° C. (Table 9A and Table 9B). The laboratory-processed material shows a slightly higher NV (70.41 vs. 68.3-69.8). The 2′DRR values are similar, but the laboratory-processed fines have a significantly higher ΔDRR (41 vs. 34).

The laboratory-processed mix #3 samples may also be compared with the corresponding plant-processed mix #3 samples, also heated at 200° C. (Table 9A and Table 9B). The laboratory-processed material shows a somewhat higher NV (73.93, 71.63 vs. ˜67-69), significantly higher ΔDRR (39.4, 32.1 vs. ˜24-26), and a somewhat to significantly lower 2′ DRR (38, 44.4 vs. ˜45-47). These comparisons indicate a difference manifested by processing conditions in the laboratory vs. similar conditions in the production-scale fluidizer operation.

### Example 2

Four full batches were prepared with assigned lot#: 72592, 72606, 72619 and 72627. In the process for this trial DKP and MgO were added as MCPA stabilization additives, material was heated at 175° C. on the fluidizer for 2 hours. All of the in-process material had very low aluminum (<200 ppm). With the exception of the packed product manufactured in the first mix (lot # 72592), all other packed product from the trial had aluminum below 200 ppm as Al, in compliance with European regulations. Packed product has neutralizing values between about 62 to 74, 2′ DRR values between about 32 to 39, and ΔDRR values between about 31 and 41. It was demonstrated in this full batch trial that product with compliance with European regulations regarding Al content can be consistently prepared with desired functionality (reactivity delay) comparable to the one of current, commercial PYRAN.

### 1. Introduction

Four full batches (mixes #1-4) of low aluminum stabilized anhydrous monocalcium phosphate (MCPA) were prepared. Mix #1 and mix #2 were prepared with larger amount of Ca(OH)₂, which resulted in material with a higher Ca/P ratio and also a larger % of DCPA. % of coating material (DKP and MgO) was the same in 3 batches (2^{nd}-4^{th}) and slightly higher in mix #1. Mix #3 and mix #4 were prepared with milled oversize material (MOS) from the 1st mix, and were basically identical in composition. Samples from the mixer, fines before the fluidizer, oversize material, and fines after heating on the fluidizer at 30 minutes increments, up to 2 hours, were collected. All collected samples were analyzed for Al, Ca, K, Mg, LOI, and P₂O₅. Dough rate of reaction (DRR) parameters were determined for samples heated on fluidizer and on packed material.

### 2. Experimental

### Raw Materials:

TABLE 11
Raw materials used in the trial.

| Chemical | Material # | Comments |
|---|---|---|
| MCPA | 20000748 | Heel for mix #1 and 2 |
| Pyran E1 MOS | 10004465 | Heel for mix #3 and 4 is |
| | | oversize from mix #1 |
| 80% H₃PO₄ | 20000325 | |
| Calcium Oxide, CaO | 30000797 | Microcal O, quick lime |
| Calcium Hydroxide | 30000093 | Min. 74% |
| Dipotassium Phosphate | 10003158 | Granular |
| (DKP) | | |
| Magnesium Oxide, | 30000862 | Dead Sea Periclase |
| MgO | | |
| TriCalcium Phosphate, | 10000184 | Flow agent |
| TCP | | |

### Analytical Procedures:

Sizing (100 USSS screen), % DCPA, and loss on drying (% LOD) were determined on the in-process samples before emptying the mixer for sizing and milling, in the unit lab. % LOD was measured at 150° C. % LOI was determined either by heating in an oven at 800° C. or by thermogravimetric analysis at 900° C.

### 3. Results and Discussion

Mix #1-4 corresponds to the packed material lot# 72592, 72606, 72619 and 72627, respectively. Preparation of the mixes will be described followed by characterization of collected samples and comparison of the material manufactured in full batch trial to the material from half batch trials.

### 3.1 Manufacturing

The production was cleaned prior to the trial.

### 3.1.1 Mixer

All four mixes were prepared with the same 2.57 K/Mg molar ratio (Table 12). Ca(OH)₂ varied from 350 lbs in mix #1 and mix #2 to 300 lbs in mixes 3 and 4. The levels of DKP and MgO were the same in mixes #2-4. The ingredient levels for mixes #3 and #4 were the same. Heel material for mix #1 and mix #2 was un-coated MCPA with Al=132 ppm; for mix #3 and mix #4, the heel was milled oversize (MOS) material produced from mix #1 (Al=132 ppm).

TABLE 12
Composition of mixes made in the trial.

| Raw Materials | Mix#1_012317 | Mix#2_012417 | Mix#3_012517 | Mix#4_012167 |
|---|---|---|---|---|
| 80% H₃PO₄ Acid (lbs) | 5676 | 5676 | 5683 | 5678 |
| Heel Material (lbs) | 2815 | 3763 | 3685 | 3813 |
| CaO (lbs) | 1410 | 1412 | 1301 | 1301 |
| Ca(OH)₂ (lbs) | 350 | 350 | 300 | 300 |
| DKP (lbs) | 500 | 400 | 400 | 400 |
| MgO (lbs) | 90 | 72 | 72 | 72 |
| TCP (lbs) | 176 | 176 | 176 | 176 |
| Total Mix (lbs) | 11017 | 11849 | 11617 | 11740 |
| Total Dry Mix (lbs) | 9465 | 10297 | 10063 | 10187 |
| water from acid (lbs) | 1552 | 1552 | 1554 | 1553 |
| % water from acid (total mix) | 14.09 | 13.10 | 13.38 | 13.23 |
| % DKP in total dry mix | 5.28 | 3.88 | 3.98 | 3.93 |
| % MgO in total dry mix | 0.95 | 0.70 | 0.72 | 0.71 |
| % K in total dry mix | 2.37 | 1.74 | 1.78 | 1.76 |
| % Mg in total dry mix | 0.57 | 0.42 | 0.43 | 0.43 |
| K/Mg mole ratio in dry mix | 2.57 | 2.57 | 2.57 | 2.57 |

Decrease in Ca(OH)₂ resulted in mixes with lower %DCPA (Table 13), from ˜10% in mix #1 to ˜4% in mix #3 and mix #4. % of oversize material (%OS) was also low for all of the mixes (<20%).

TABLE 13
Mixes characteristics before emptying from the mixer: % DCPA
as P₂O₅, % LOD, % of oversize material (% OS, +100 mesh)
and the time in the mixer before the unloading.

| | % DCPA | % LOD | % OS | Time in |
|---|---|---|---|---|
| Mix# | (as P₂O₅) | (150° C./10′) | (+100 mesh) | the mixer* |
| 1 | 10.1 | 0.18 | 20.4 | 4 h 30 min |
| 2 | 9.8 | 0.04 | 17.1 | 4 h 20 min |
| 3 | 4 | 0.11 | 15.5 | 4 h 5 min |
| 4 | 4.5 | 0.2 | 13.8 | 4 h 10 min |

*after the addition of the acid and quick lime until emptying from the mixer.

### 3.1.2 Fluidizer

Fine material from the mixes was conveyed to the fluidizer set at 175° C., and heated for 2 hours after reaching the set temperature. Material was sampled every 30 minutes. The weight of the product from the mixer, and the weight of the fines separated from the mix and charged to the fluidizer, are provided in Table 14. Depending on the mix, the fines charged to the fluidizer represent from 38 to 68% of the mix.

TABLE 14
Weight of the batch (from the Mixer), and weight of fines
conveyed to the fluidizer for mixes #1-4, used to calculate
% fines (fraction of the batch processed on fluidizer).

| | Final Product | | |
|---|---|---|---|
| | (lbs) from the | Fluidizer | % Mix on |
| Mix# | Mixer | charge (lbs) | fluidizer |
| 1 | 10394 | 5991 | 57.6 |
| 2 | 11225 | 5395 | 48.1 |
| 3 | 11053 | 7463 | 67.5 |
| 4 | 11176 | 4242 | 38.0 |

### 3.1.3 Finished Product

Four full batch mixes (#1-4) were processed to the packed product, with assigned lot #s 72592, 72606, 72619 and 72627, respectively. Yield from each of the mixes #1-4 was 5787, 3417, 7276 and 5236 lbs, respectively.

### 3.2 Samples Analyses

### 3.2.1 Aluminum

Aluminum in the in-process samples (Table 15) was low (<150 ppm in all of the mixes (charges). A continuous drop in the Al level is observed in successive charges, from ˜130 ppm in charge #1 to ˜80 ppm in charge #4. Oversize material had similar Al content as fines. Packed material had consistently higher level of Al than the material from fluidizer. The levels of aluminum increase as the finished fluidizer charges are packed, indicative of a pickup of aluminum in the packing system. The amount of increase declines as later charges are packed as aluminum is flushed out of the packing system.

TABLE 15
Aluminum in in-process samples for mixes (charges) #1-4 and
in the packed material in lot 72592, 72606, 72619 and 72627);
also oversize material (OS). Sample Key: Mixer (S);
Fines before fluidizing (fines); Finished fluidizer charge
(120 min); Finished product (lot).

| | |
|---|---|
| Sample ID | Al (ppm) |

Samples derived from mix #1.

| | |
|---|---|
| Ch#1_S1 | 117 |
| Ch#1_0S | 132 |
| Ch#1_fines | 132 |
| Ch#1_120min | 144 |
| Pyran E1 lot 72592 | 275 |

Samples derived from mix #2

| | |
|---|---|
| Mix #2 fines | 119 |
| Mix #2_OS | 111 |
| Pyran E1 lot 72606 | 134 |

Samples derived from mix #3

| | |
|---|---|
| Ch#3_S2 | 92 |
| Ch#3_fines | 88 |
| Ch#3_oversize | 104 |
| Ch#3_120min | 93 |
| Pyran E1 lot 72619 | 105.8 |

Samples derived from mix #4

| | |
|---|---|
| Ch#4_S2 | 81 |
| Mix#4_fines | 82 |
| Mix#4_OS | 86 |
| Ch#4_2hr | 91 |
| Pyran E1 72627 | 111.8 |

### 3.2.2% Ca, % P₂O₅, and % DCPA

The % Ca, % P₂O₅, and Ca/P mole ratios are presented in Tables 16-19 for the mixer, fines, oversize, and fluidizer samples generated from mixes #1 to #4.

It is seen from the Ca/P mole ratios in Tables 16-19 that Ca in the mixes tends to segregate towards the oversize material upon screening, while P₂O₅ favors the fines.

TABLE 16
% of Ca, % P₂O₅, and Ca/P, in the in-process samples from
mix (charge) #1 trial. Ch#1 average (fines) is the average
values in fine material, both before and on heating.

| | | | Molar |
|---|---|---|---|
| Charge 1 | % Ca | % P₂O₅ | Ca/P |
| Ch#1_S1 | 18.2 | 56.46 | 0.571 |
| Ch#1_S2 | 16.7 | 56.56 | 0.523 |
| Ch#1_S3 | 17.8 | 57.63 | 0.547 |
| Ch#1_S4 | 18.3 | 57.24 | 0.566 |
| Ch#1_OS | 20.3 | 54.97 | 0.654 |
| Ch#1_fines | 17.7 | 57.56 | 0.545 |
| Ch#1_30 min | 17.6 | 57.77 | 0.540 |
| Ch#1_60 min | 17.9 | 57.52 | 0.551 |
| Ch#1_90 min | 17.7 | 57.84 | 0.542 |
| Ch#1_120 min | 17.7 | 57.77 | 0.543 |
| Ch#1_average (fines) | 17.72 | 57.69 | 0.54 |
| Ch#1 stdev (fines) | 0.10 | 0.13 | 0.00 |

TABLE 17
% of Ca, % P₂O₅, and Ca/P in the in-process samples from
mix (charge) #2 trial. Ch#2 average (fines) is the
average values in fine material, both before and on heating.

| | | | Molar |
|---|---|---|---|
| Charge 2 | % Ca | % P₂O₅ | Ca/P |
| Ch#2_S1 | 16.9 | 56.9 | 0.526 |
| Ch#2_S2 | 17.6 | 57.04 | 0.547 |
| Mix#2 fines | 17.2 | 60.61 | 0.503 |
| Mix#2_OS | 19.2 | 55.62 | 0.611 |
| Ch#2_30 min | 17 | 58 | 0.519 |
| Ch#2_1 hr | 16.9 | 57.86 | 0.517 |
| Ch#2_1 hr 30 min | 17.2 | 57.91 | 0.526 |
| Ch#2_2 hr | 17.1 | 57.93 | 0.523 |
| Ch#2_average (fines) | 17.08 | 58.46 | 0.52 |
| Ch#2 stdev (fines) | 0.12 | 1.07 | 0.01 |

TABLE 18
% of Ca, % P₂O₅, and Ca/P in the in-process samples from mix (charge)
#3 trial and packed product (72619). Ch#3 average (fines)
is the average values in fine material, both before and on heating.

| | | | Molar |
|---|---|---|---|
| Charge 3 | % Ca | % P₂O₅ | Ca/P |
| Ch#3_S1 | 15.6 | 59.28 | 0.466 |
| Ch#3_S2 | 15.7 | 58.69 | 0.474 |
| Ch#3_fines | 14.8 | 59.35 | 0.442 |
| Ch#3_oversize | 18.3 | 55.82 | 0.581 |
| Ch#3_30 min | 15.4 | 59.47 | 0.459 |
| Ch#3_60 min | 15.3 | 59.31 | 0.457 |
| Ch#3_90 min | 15.3 | 59.31 | 0.457 |
| Ch#3_120 min | 15.6 | 59.4 | 0.465 |
| Ch#3_average (fines) | 15.28 | 59.37 | 0.46 |
| Ch#3 stdev (fines) | 0.26 | 0.06 | 0.01 |
| Pyran E1 72619 | 15.80 | 59.19 | 0.47 |

TABLE 19
% of Ca, % P₂O₅, and Ca/P in the in-process samples from mix (charge)
#1 trial and packed product (72627). Ch#4 average (fines)
is the average values in fine material, both before and on heating.

| | | | Molar |
|---|---|---|---|
| Charge 4 | % Ca | % P₂O₅ | Ca/P |
| Ch#4_S1 | 15.2 | 56.49 | 0.477 |
| Ch#4_S2 | 15.6 | 58.87 | 0.469 |
| Mix#4_fines | 15.7 | 59.49 | 0.467 |
| Mix#4_OS | 19.9 | 55.48 | 0.635 |
| Ch#4_30 min | 15.6 | 59.31 | 0.466 |
| Ch#4_1 hr | 15.4 | 59.24 | 0.460 |
| Ch#4_1 hr 30 min | 15.7 | 59.33 | 0.469 |
| Ch#4_2 hr | 15.5 | 15.17 | 0.464 |
| Ch#4_average (fines) | 15.58 | 59.31 | 0.47 |
| Ch#4 stdev (fines) | 0.12 | 0.11 | 0.00 |
| Pyran E1 72627 | 15.70 | 59.37 | 0.47 |

% DCPA in the material heated in fluidizer for 2 hours (7.7, 7.3, 4.2 and 4) for mixes #1-4, respectively) were consistent with % DCPA in the mixes before unloading the mixer.

### 3.2.3% K, % Mg, mole ratio K/Mg

The % K and % Mg are given in Tables 20-23 for the mixer, fines, oversize, and fluidizer samples generated from mixes #1 to #4.

TABLE 20
% Ca, % Mg, and K/Mg molar ratio in the in-process samples
from mix (charge) #1 trial. Ch#1 average (fines) is
the average values in fine material, both before and on heating.

| | | | Molar |
|---|---|---|---|
| Charge 1 | % K | % Mg | K/Mg |
| Ch#1_S1 | 1.68 | 0.45 | 2.32 |
| Ch#1_S2 | 1.58 | 0.49 | 2.00 |
| Ch#1_S3 | 1.63 | 0.4 | 2.53 |
| Ch#1_S4 | 1.58 | 0.41 | 2.40 |
| Ch#1_OS | 0.96 | 0.2 | 2.98 |
| Ch#1_fines | 1.64 | 0.5 | 2.04 |
| Ch#1_30 min | 1.78 | 0.48 | 2.31 |
| Ch#1_60 min | 1.84 | 0.49 | 2.33 |
| Ch#1_90 min | 1.77 | 0.5 | 2.20 |
| Ch#1_120 min | 1.81 | 0.51 | 2.21 |
| Ch#1_average (fines) | 1.74 | 0.48 | 2.25 |
| Ch#1 stdev (fines) | 0.09 | 0.03 | 0.12 |

TABLE 21
% Ca, % Mg, and K/Mg molar ratio in the in-process samples
from mix (charge) #2 trial. Ch#2 average (fines) is
the average values in fine material, both before and on heating.

| | | | Molar |
|---|---|---|---|
| Charge 2 | % K | % Mg | K/Mg |
| Ch#2_S1 | 1.56 | 0.32 | 3.03 |
| Ch#2_S2 | 1.41 | 0.32 | 2.74 |
| Mix#2 fines | 1.52 | 0.36 | 2.62 |
| Mix#2_OS | 1.17 | 0.23 | 3.16 |
| Ch#2_30 min | 1.51 | 0.36 | 2.61 |
| Ch#2_1 hr | 1.49 | 0.36 | 2.57 |
| Ch#2_1 hr 30 min | 1.49 | 0.38 | 2.44 |
| Ch#2_2 hr | 1.48 | 0.38 | 2.42 |
| Ch#2_average (fines) | 1.50 | 0.7 | 2.53 |
| Ch#2 stdev (fines) | 0.01 | 0.01 | 0.09 |

TABLE 22
% Ca, % Mg, and K/Mg molar ratio in the in-process
samples from mix (charge) #3 trial and packed
product (72619). Ch#3 average (fines) is the average
values in fine material, both before and on heating.

| | | | Molar |
|---|---|---|---|
| Charge 3 | % K | % Mg | K/Mg |
| Ch#3_S1 | 1.8 | 0.39 | 2.87 |
| Ch#3_S2 | 1.57 | 0.34 | 2.87 |
| Ch#3_fines | 1.73 | 0.37 | 2.91 |
| Ch#3_oversize | 1.32 | 0.3 | 2.74 |
| Ch#3_30 min | 1.74 | 0.39 | 2.77 |
| Ch#3_60 min | 1.83 | 0.39 | 2.92 |
| Ch#3_90 min | 1.79 | 0.39 | 2.85 |
| Ch#3_120 min | 1.81 | 0.38 | 2.96 |
| Ch#3_average (fines) | 1.78 | 0.38 | 2.88 |
| Ch#3 stdev (fines) | 0.04 | 0.01 | 0.06 |
| Pyran E1 72619 | 1.91 | 0.42 | 2.83 |

TABLE 23
% Ca, % Mg, and K/Mg molar ratio in the in-process
samples from mix (charge) #4 trial and packed
product (72627). Ch#4 average (fines) is the average
values in fine material, both before and on heating.

| | | | Molar |
|---|---|---|---|
| Charge 4 | % K | % Mg | K/Mg |
| Ch#4_S1 | 1.87 | 0.4 | 2.91 |
| Ch#4_S2 | 1.89 | 0.4 | 2.94 |
| Mix#4_fines | 2.05 | 0.41 | 3.11 |
| Mix#4_OS | 1.49 | 0.38 | 2.44 |
| Ch#4_30 min | 1.94 | 0.4 | 3.01 |
| Ch#4_1 hr | 1.98 | 0.39 | 3.16 |
| Ch#4_1 hr 30 min | 1.92 | 0.4 | 2.98 |
| Ch#4_2 hr | 1.97 | 0.4 | 3.06 |
| Ch#4_average (fines) | 1.97 | 0.40 | 3.06 |
| Ch#4 stdev (fines) | 0.04 | 0.01 | 0.06 |
| Pyran E1 72627 | 1.93 | 0.42 | 2.86 |

### 3.2.4% LOI

The % LOI values are given in Tables 24A -24D for the mixer, fines, oversize, and fluidizer samples generated from mixes #1 to #4.

Tables 24A-D. % LOI of samples in charges #1-4.

TABLE 24A

| Charge 1 | % LOI |
|---|---|
| Ch#1_S1 | 13.7 |
| Ch#1_S2 | 13.56 |
| Ch#1_S3 | 12.9 |
| Ch#1_S4 | 12.65 |
| Ch#1_OS | 12.55 |
| Ch#1_fines | 12.66 |
| Ch#1_30 min | 12.12 |
| Ch#1_60 min | 12.12 |
| Ch#1_90 min | 12.14 |
| Ch#1_120 min | 12.12 |
| Pyran E1 lot 72592 | 12.24 |

TABLE 24B

| Charge 2 | % LOI |
|---|---|
| Ch#2_S1 | 12.85 |
| Ch#2_S2 | 12.69 |
| Mix#2 fines | 12.55 |
| Mix#2_OS | 12.78 |
| Ch#2_30 min | 12.58 |
| Ch#2_1 hr | 12.6 |
| Ch#2_1 hr 30 min | 12.65 |
| Ch#2_2 hr | 12.59 |
| Pyran E1 lot 72606 | 12.62 |

TABLE 24C

| Charge 3 | % LOI |
|---|---|
| Ch#3_S1 | 13.68 |
| Ch#3_S2 | 13.28 |
| Ch#3_fines | 13.15 |
| Ch#3_oversize | 12.56 |
| Ch#3_30 min | 13.13 |
| Ch#3_60 min | 13.13 |
| Ch#3_90 min | 13.21 |
| Ch#3_120 min | 13.1 |
| Pyran E1 72619 | 13.29 |

TABLE 24D

| Charge 4 | % LOI |
|---|---|
| Ch#4_S1 | 13.69 |
| Ch#4_S2 | 13.36 |
| Mix#4_fines | 13.17 |
| Mix#4_OS | 12.3 |
| Ch#4_30 min | 13.07 |
| Ch#4_1 hr | 13.11 |
| Ch#4_1 hr 30 min | 13.04 |
| Ch#4_2 hr_012617 | 13.02 |
| Pyran E1 72627 | 13.21 |

### 3.2.6 NV and DRR

Neutralizing values (NV) and dough rate of reaction (DRR) parameters were determined in all 4 mixes for samples heated on the fluidizer for 30, 60, 90 and 120 minutes, and for the packed material (Tables 25-28). NV was lower in the product obtained from mix #1 and mix #2 (˜62 and 65) than NV in the product from mix #3 and mix #4 (˜73).

The higher Ca/P mole ratios and % DCP levels are associated with the lower neutralizing values observed for in-process and finished lot samples derived from mix #1 and #2.

Mix #1 was prepared with a high Ca/P mole ratio and a high level of K and Mg additives. Mix #2 was prepared with a high Ca/P mole ratio and a lower level of K and Mg additives. Mixes #3 and #4 were prepared using both a lower Ca/P mole ratio and a lower level of K and Mg additives. In-process and finished lot samples from mixes #3 and #4 exhibit, in combination, higher neutralizing values, lower 2′ DRR values (32-34), and higher delta DRR values (˜41) compared with the results from mixes #1 and #2.

TABLE 25
NV and DRR of samples from mix #1 trial.

| Charge 1 | NV | 2′ DRR | ΔDRR |
|---|---|---|---|
| Ch#1_30 min | 63 | 36.2 | 31.5 |
| Ch#1_60 min | 63.09 | 34.5 | 32.2 |
| Ch#1_90 min | 62.64 | 34 | 33.6 |
| Ch#1_120 min | 63.72 | 34.9 | 31.7 |
| Pyran E1 lot 72592 | 62.5 | 34 | 33 |

TABLE 26
NV and DRR of samples from mix #2 trial.

| Charge 2 | NV | 2′ DRR | ΔDRR |
|---|---|---|---|
| Ch#2_30 min | 65.94 | 39 | 31.3 |
| Ch#2_1 hr | 66.01 | 39.1 | 31.5 |
| Ch#2_1 hr 30 min | 66.9 | 39.5 | 29.8 |
| Ch#2_2 hr | 65.18 | 39.2 | 32 |
| Pyran E1 lot 72606 | 65.3 | 39 | 31.1 |

TABLE 27
NV and DRR of samples from mix #3 trial.

| Charge 3 | NV | 2′ DRR | ΔDRR |
|---|---|---|---|
| Ch#3_30 min | 73.3 | 32.1 | 42.7 |
| Ch#3_60 min | 74.54 | 31.9 | 41.2 |
| Ch#3_90 min | 73.95 | 31.9 | 41.2 |
| Ch#3_120 min | 73.77 | 30.9 | 42.8 |
| Pyran E1 72619 | 73 | 32 | 41.2 |

TABLE 28
NV and DRR of samples from mix #4 trial.

| Charge 4 | NV | 2′ DRR | ΔDRR |
|---|---|---|---|
| Ch#4_30 min | 73.66 | 33.3 | 41.5 |
| Ch#4_1 hr | 74.05 | 33.1 | 41.2 |
| Ch#4_1 hr 30 min | 73.79 | 31.8 | 41 |
| Ch#4_2 hr | 73.04 | 33.3 | 38.9 |
| Pyran E1 72627 | 73.7 | 34 | 40.7 |

TABLE 29
Half Batch and Full Batch production parameters: input % K and % Mg refer to the mix composition,
% K, % Mg refer to the composition of the packed product.

| | Dried Mix | | | Fluidized Charge or Finished Lot | | | | | | | |
|---|---|---|---|---|---|---|---|---|---|---|---|
| | | | K/Mg | | | K/Mg | Ca/P | | | | |
| Charge or | | | Mole | | | Mole | Mole | | | | |
| Lot# | % K | % Mg | Ratio | % K | % Mg | Ratio | Ratio | NV | 2′ DRR | ΔDRR | Al (ppm) |
| unmodified | — | — | — | — | — | — | — | — | typ. | typ. | — |
| MCPA | | | | | | | | | ~60-65 | ~80-85 | |
| PYRAN | — | — | — | — | — | — | — | 80-86 | 36 max. | 42 min | typ. |
| | | | | | | | | | | | ~900-1000 |
| Ch #1 | 2.25 | 0.57 | 2.45 | ~2.2 | ~0.6 | ~2.3 | | | | | |
| Ch #2 | 2.17 | 0.55 | 2.45 | ~2.2 | ~0.6 | ~2.3 | | 69.80 | 35.6 | 34.0 | 334 |
| Ch #3 | 2.49 | 0.37 | 4.18 | ~2.5 | ~0.4 | ~3.8 | | 67.38 | 45.9 | 25.5 | 393 |
| Ch #3 - | 2.49 | 0.37 | 4.18 | ~2.6 | ~0.4 | ~4.0 | | 75.10 | 41.3 | 33.8 | ~400-450 |
| 175° C. Lab | | | | | | | | | | | |
| Ch #3 - | 2.49 | 0.37 | 4.18 | ~2.6 | ~0.4 | ~4.0 | | 71.63 | 44.4 | 32.1 | ~400-450 |
| 200° C. Lab | | | | | | | | | | | |
| 69989 | 2.26 | 0.57 | 2.46 | 1.78 | 0.61 | 1.81 | | 68.28 | 34.4 | 34.2 | 349 |
| 69998 | 1.54 | 0.39 | 2.45 | 1.77 | 0.61 | 1.80 | 0.57 | 67.9 | 45.5 | 24.9 | 398 |
| Ch #1 | 2.37 | 0.57 | 2.58 | 1.74 | 0.49 | 2.21 | | 63.72 | 34.9 | 31.7 | 144 |
| Ch #2 | 1.74 | 0.42 | 2.57 | 1.50 | 0.37 | 2.52 | | 65.18 | 39.2 | 32.0 | <150 |
| Ch #3 | 1.78 | 0.43 | 2.57 | 1.78 | 0.38 | 2.91 | | 73.77 | 30.9 | 42.8 | 93 |
| Ch #4 | 1.76 | 0.43 | 2.54 | 1.97 | 0.40 | 3.06 | | 73.04 | 33.3 | 38.9 | 91 |
| 72592 | 2.37 | 0.57 | 2.58 | 1.74 | 0.49 | 2.21 | | 62.50 | 34 | 33.0 | 275 |
| 72606 | 1.74 | 0.42 | 2.57 | 1.50 | 0.37 | 2.52 | | 65.30 | 39 | 31.1 | 134 |
| 72619 | 1.78 | 0.43 | 2.57 | 1.81 | 0.38 | 2.96 | 0.47 | 73.00 | 32 | 41.2 | 106 |
| 72627 | 1.76 | 0.43 | 2.54 | 1.97 | 0.40 | 3.06 | 0.47 | 73.70 | 34 | 40.7 | 112 |

The breadth and scope of the present disclosure should not be limited by any of the above-described exemplary embodiments, but should be defined only in accordance with the following claims and their equivalents.

### REFERENCES

1. Commission Regulation (EU) No 380/2012; Official Journal of the European Union; L/119/14; http://world wide web site: eur-lex.europa.eu/LexUriServ/LexUriServ.do?uri=0J1:2012:119:0014:0038:EN:PDF
2. PYRAN product data sheet at the http://world wide web site: nadomino.onescope.net/Magellan/AstarisReferenceV2.nsf/TechnicalDataFormEnqlish.xsp?action=openDocument&documentld=BEC2CDE98A7096C486256AB800684122
3. G. W. Cadwallader ‘PYRAN Process: V-90 Test Mix’ MSL_report 10596, Oct. 31, 1990.
4. http://world wide web address: eur-lex.europa.eu/legalcontent/EN/TXT/PDF/?uri=OJ:L:2012:083:FULL&from=EN

What is claimed is:

1. A stabilized anhydrous monocalcium phosphate (MCPA) leavening composition comprising MCPA and a non-aluminum stabilizer.

2. The stabilized MCPA leavening composition of claim 1, wherein the MCPA is in an amount of about 80% to about 98%, by weight, and the non-aluminum stabilizer is in an amount of about 1.3% to about 8%, by weight, or the non-aluminum stabilizer is in an amount of about 6% to about 7%, by weight.

3. The stabilized MCPA leavening composition of claim 1 or 2, wherein the non-aluminum stabilizer comprises at least one ingredient selected from the group of ingredients consisting of DKP, MKP, TKPP, MgO, MgCO₃, Mg(OH)₂, and Ca(OH)₂.

4. The stabilized MCPA leavening composition of claim 1, wherein the non-aluminum stabilizer comprises at least one of each of the following: (i) a potassium phosphate; and (ii) a magnesium or calcium base.

5. The stabilized MCPA leavening composition of claim 4, wherein the potassium phosphate comprises at least one potassium phosphate selected from the group consisting of DKP, MKP, and TKPP, and the magnesium or calcium base comprises at least one base selected from the group consisting of MgO, MgCO₃, Mg(OH)₂, and Ca(OH)₂.

6. The stabilized MCPA leavening composition of claim 5, wherein the non-aluminum stabilizer comprises DKP and MgO.

7. The stabilized MCPA leavening composition of claim 4, wherein the potassium phosphate and base combined are in an amount of about 1.3% to about 8%, by weight, or the potassium phosphate and base combined are in an amount of about 6% to about 7% by weight;
optionally wherein [K+Mg] is from about 0.7% to about 4%, by weight.

8. The stabilized MCPA leavening composition of claim 7, wherein the potassium phosphate is in an amount of about 1% to about 6%, by weight, or the potassium phosphate is in an amount of about 3% to about 6%, by weight, and the magnesium or calcium base is in an amount of about 0.3% to about 2%, by weight, or the magnesium or calcium base is in an amount of about 0.7% to about 1.4%, by weight.

9. The stabilized MCPA leavening composition of claim 6, where the DKP is in an amount of about 1% to about 6%, by weight, or the DKP is in an amount of about 3% to about 6%, by weight, and the MgO is in an amount of about 0.3% to about 2%, by weight, or the MgO is in an amount of about 0.7% to about 1.4%, by weight.

10. The stabilized MCPA leavening composition of any one of claims 1 to 9, wherein the leavening composition comprises a K/Mg mole ratio of from about 0.3 to about 10, of from about 1 to about 5, of from about 2 to 6, or of from about 1.35 to about 3.4.

11. The stabilized MCPA leavening composition of any one of claims 1 to 10, wherein the leavening composition comprises less than about 1000 ppm, 900 ppm, 800 ppm, 700 ppm, 600 ppm, 500 ppm, 450 ppm, 400 ppm, 350 ppm, 300 ppm, 250 ppm, 200 ppm, 150 ppm, or 100 ppm of aluminum.

12. The stabilized MCPA leavening composition of any one of claims 1 to 11, wherein stabilization of MCPA is achieved without utilizing an aluminum compound.

13. The stabilized MCPA leavening composition of any one of claims 1 to 12, wherein the leavening composition does not contain added aluminum phosphates.

14. The stabilized MCPA leavening composition of any one of claims 1 to 13, wherein the stabilized MCPA leavening composition exhibits delayed reactivity with baking soda in a dough mixture in comparison with a control of MCPA without stabilization;
optionally wherein the reactivity is quantified as the dough rate of reaction (DRR),
optionally wherein the reactivity is significantly delayed.

15. The stabilized MCPA leavening composition of any one of claims 1 to 13, wherein the stabilized MCPA leavening composition exhibits similar reactivity with baking soda in a dough mixture in comparison with a control leavening composition of MCPA coated with MALP,
optionally wherein the reactivity is quantified as the dough rate of reaction (DRR).

16. The stabilized MCPA leavening composition of any one of claims 1 to 13, wherein the stabilized MCPA leavening composition exhibits delayed reactivity with baking soda in a dough mixture in comparison with a control leavening composition of MCPA coated with monoaluminum phosphate MALP,
optionally wherein the reactivity is quantified as the dough rate of reaction (DRR).

17. The stabilized MCPA leavening composition of any one of claims 1 to 16, wherein the 2′ DRR is <55, <50, <45, or <40; optionally, wherein the 2′ DRR is between about 30 and about 55, between about 30 and about 50, between about 30 and 45, between about 30 and 40, between about 35 and about 55, between about 35 and about 50, or between about 35 and about 45.

18. The stabilized MCPA leavening composition of any one of claims 1 to 17, wherein the leavening composition has a neutralizing value (NV) of at least 60, at least 65, at least 70, at least 75, or at least 80.
